(19) United States
(12) Patent Application Publication
(10) Pub. No.: US 2011/0076112 A1
(43) Pub. Date: Mar. 31, 2011

(54) CONCRETE BOLT

(76) Inventor: Chi-Tao Huang, Taipei City (TW)

(21) Appl. No.: 12/826,125

(22) Filed: Jun. 29, 2010

(30) Foreign Application Priority Data
Sep. 25, 2009 (TW) 098217710

(51) Int. Cl. F16B 33/02

(52) U.S. Cl. 411/412

(57) ABSTRACT

A concrete bolt includes a hexagonal head part and a bolt body extended from the head part. A bottom end of the bolt body is a bevel, a surface of the bolt body has high-tooth and low-tooth threads helically extended and arranged alternately. A tooth end of the high-tooth thread is tilted outward, an end surface facing toward the head part is concaved, the low-tooth thread is roughly in a trapezoidal shape and a high-tooth thread adjacent to the bottom end has petal-shaped teeth arranged alternately. When locking into concrete, the bolt is operated more easily to save labor work by cutting with the high-tooth threads and guiding and balancing functions with the low-tooth threads. Additionally, the concrete cut is coagulated after locking, thus the bolt is more robust by having a high tensile strength and easily dismantled for repetitive use, thereby improving a practical value of the concrete bolt.

### BACKGROUND OF THE INVENTION

a) Field of the Invention

The present invention relates to a concrete bolt and more particularly to an expansion bolt which is operated easily to save labor work, is provided with a high tensile strength that it is more robust after being locked in, and can be easily dismantled to use repeatedly.

b) Description of the Prior Art

As a body of an ordinary concrete bolt to be locked into concrete is only provided with helical threads, following problems usually exist when the bolt is locked into the concrete:
1. A cutting effect is inferior when the bolt is locked into the concrete; therefore, the operation will waste time and labor work, thereby affecting an efficiency of implementation.
2. As guiding and balancing effects are inferior, it is difficult to keep the bolt vertical when the bolt is being locked in, causing the bolt to tilt and affecting an engineering quality.
3. As the bolt is weaker, it is fractured easily during operation.
4. The tensile strength is insufficient that the bolt is not robust enough and it is disadvantageous to dismantle the bolt for repetitive use.

Accordingly, the present invention is to provide a concrete bolt which can be used more conveniently, can save labor work and is more robust.

### SUMMARY OF THE INVENTION

The primary object of the present invention is to provide a concrete bolt, allowing that the expansion bolt can be operated easily to save labor work, can be provided with a high tensile strength that it is more robust after being locked into concrete, and can be easily dismantled to use repeatedly.

The aforementioned concrete bolt includes primarily a hexagonal head part and a bolt body which is extended from the head part. A bottom end of the bolt body is provided with a bevel and a surface of the bolt body is provided with high-tooth threads and low-tooth threads which are extended helically and arranged alternately, wherein a tooth end of the high-tooth thread is tilted outward and an end surface facing toward the head part is concaved, whereas the low-tooth thread is in a trapezoidal shape and the high-tooth thread adjacent to the bottom end is provided with petal-shaped teeth which are arranged alternately. When the bolt is locked into the concrete, by cutting of the high-tooth threads and guiding and balancing functions of the low-tooth threads, the bolt can be operated more easily to save labor work. In addition, after the bolt has been locked in, the concrete cut is coagulated, allowing that the bolt is provided with a high tensile strength to be more robust and can be easily dismantled to be used repeatedly, thereby improving a practical value of the bolt.

For the aforementioned concrete bolt, helix angles formed between the high-tooth threads, low-tooth threads and the bolt body are between 15° and 25° to construct the high tensile strength.

The aforementioned concrete bolt is provided with a high-tooth thread of petal-shaped teeth, which is located at 0^{˜}15 or 40 mm above the bottom end of the bolt body (about 2^{˜}2.5 times of the diameter), so as to increase sharpness of the bolt upon being locked into the concrete.

For the aforementioned concrete bolt, inclination angles at an upper and lower rim of the low-tooth thread are about 50°^{˜}58° to achieve the guiding and balancing functions, allowing the bolt to keep vertical during operation.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of the present invention.

FIG. 2 shows a locally exploded three-dimensional view of the present invention.

FIG. 3 shows a cutaway view of a high-tooth thread and a low-tooth thread of the present invention.

FIG. 4 shows a cutaway view of a high-tooth thread having petal-shaped teeth, according to the present invention.

### DETAILED DESCRIPTION OF THE PREFERRED EMBODIMENTS

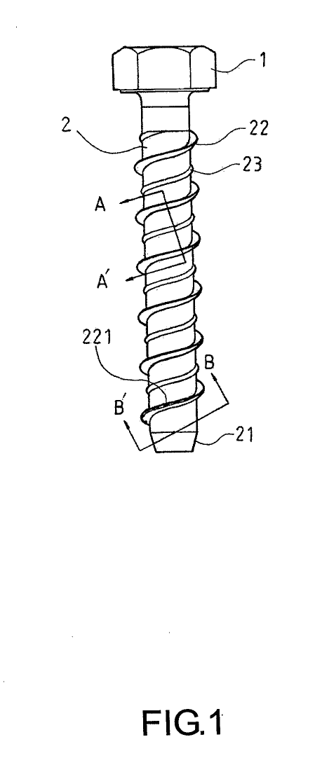

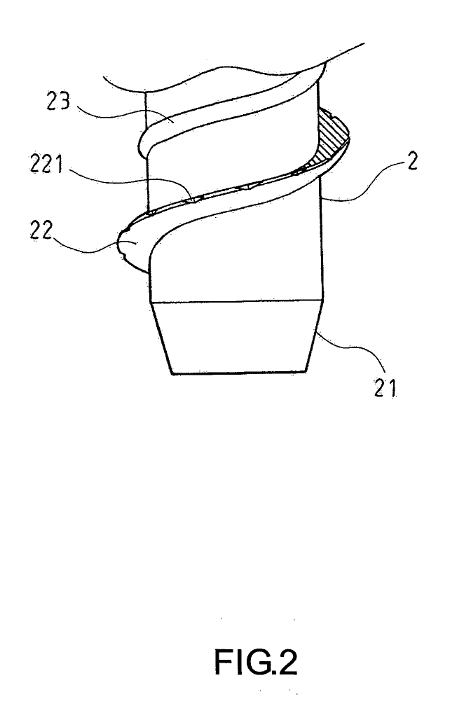

Referring to FIG. 1 and FIG. 2, it shows a three-dimensional view and a locally exploded three-dimensional view of the present invention. As shown in the drawings, the present invention comprises primarily a hexagonal head part 1 (this specification uses the hexagonal shape as the embodiment, however, other shapes also apply) and a bolt body 2 which is extended with a proper length from the head part 1. A bottom end of the bolt body 2 is provided with a bevel 21 which is tilted inward by a proper angle from top to bottom, a surface of the bolt body 2 is provided with high-tooth threads 22 and low-tooth threads 23 which are helically extended and arranged alternately, and helix angles which are formed between the high-tooth threads 22, low-tooth threads 23 and the bolt body 2 are between 15° and 25° to construct a high tensile strength.

A tooth end of the high-tooth thread 22 is tilted outward and an end surface facing toward the head part 1 is concaved (described hereinafter); whereas, the low-tooth thread 23 is in a trapezoidal shape and a high-tooth thread 22 adjacent to the bottom end is provided with petal-shaped teeth 221 which are arranged alternately.

A concrete bolt is constructed by the aforementioned parts, such that when the bolt is locked into concrete, the bolt can be easily cut into the concrete by sharpness increased from the high-tooth threads 22 and the petal-shaped teeth 221 of the high-tooth thread 22. On the other hand, the low-tooth threads 23 can constitute guiding and balancing functions, allowing that the bolt can keep vertical during operation, the operation can be more easily to save labor work and the concrete cut can be coagulated after the bolt has been locked in, such that the bolt can be more robust by having the high tensile strength and can be easily dismantled for repetitive use, thereby improving a practical value of the bolt.

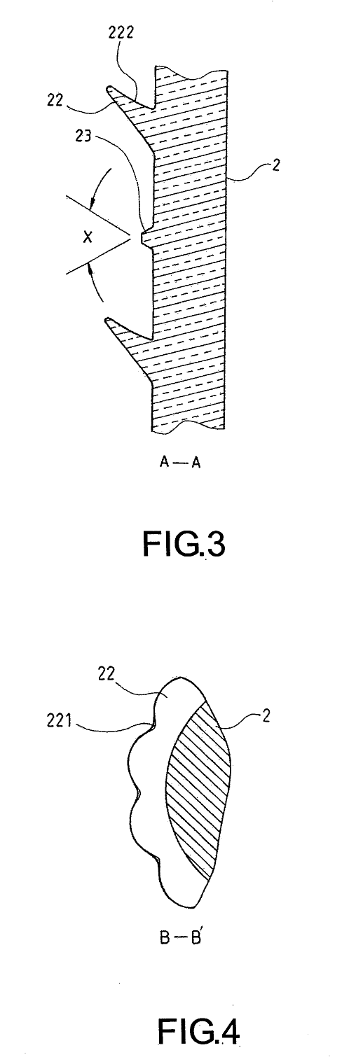

In collaboration with FIG. 1 and referring to FIG. 3 and FIG. 4 at a same time, showing a cutaway view of the high-tooth thread and the low-tooth thread of the present invention and a cutaway view of a high-tooth thread having the petal-shaped teeth according to the present invention, the high-tooth thread 22 having the petal-shaped teeth 221 of the bolt body 2 is located at 0^{˜}15 or 40 mm above the bottom end of the bolt body 2 (about 2^{˜}2.5 times of the diameter), so as to increase the sharpness of the bolt upon being locked into the concrete. The tooth end of the high-tooth thread 22 is tilted outward and the end surface facing toward the head part 1 is provided with a concaved part 222; whereas, the low-tooth thread 23 is roughly in the trapezoidal shape and inclination angles at an upper and lower rim are set at about 60° to achieve the guiding and balancing functions, thereby allowing the bolt to keep vertical during operation.

In comparison with a conventional concrete bolt, the present invention is at least provided with following advantages:
1. The bottom end of the bolt body 2 is provided with the bevel 21 to construct a strengthening function, preventing from fracture of the head part 1 and the bolt body 2 when the bolt is locked into the concrete.
2. The tooth end of the high-tooth thread 22 is tilted outward and the end surface facing toward the head part 1 is provided with the concaved part 222. This shape is provided with an effect of cutting into the concrete, with a smaller torque than other conventional bolts to facilitate operation.
3. The low-tooth thread 23 is roughly in the trapezoidal shape and the inclination angles at the upper and lower rim are set at 50°^{˜}58° to achieve the guiding and balancing functions. In addition, as an outer diameter of the low-tooth thread 23 is smaller than an aperture of the concrete, the bolt can be locked into the concrete while keeping vertical during operation.
4. The helix angles formed between the high-tooth threads 22, low-tooth threads 23 and the bolt body 2 are between 15° and 25° to construct the high tensile strength, thereby forming a strengthening bolt.
5. The high-tooth thread 22 having the petal-shaped teeth 221 is located at 0^{˜}15 or 40 mm above the bottom end of the bolt body 2 (about 2^{˜}2.5 times of the diameter), which increases the sharpness of the bolt when the bolt is locked into the concrete, so as to facilitate cutting.

Besides, after cold forming, the present invention is implemented with a multi-stage heat treatment to avoid a risk of hydrogen embrittlement and to allow a surface hardness of the bolt to be sufficient that the bolt can be easily locked into the concrete.

Accordingly, the present invention provides the concrete bolt which comprises the high-tooth threads, the low-tooth threads and the petal-shaped teeth on a high-tooth thread, allowing that the concrete bolt can be operated more easily to save labor work, the concrete bolt can be more robust after being locked into the concrete by having the high tensile strength and the concrete bolt can be easily dismantled for repetitive use.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A concrete bolt comprising a hexagonal head part, with that a bottom end of a bolt body is provided with a bevel which is titled inward by a proper angle from top to bottom and a surface of the bolt body is provided with high-tooth threads and low-tooth threads which are helically extended and arranged alternately, wherein a tooth end of the high-tooth thread is tilted outward, an end surface facing toward the head part is provided with a concaved part, the low-tooth thread is roughly in a trapezoidal shape and a high-tooth thread adjacent to the bottom end is provided with petal-shaped teeth which are arranged alternately, such that the bolt is easily cut into concrete by sharpness increased from the high-tooth threads and the petal-shaped teeth of the high-tooth thread when the bolt is locked into the concrete, whereas, the low-tooth threads constitute guiding and balancing functions, allowing the bolt to keep vertical during operation, thereby enabling the bolt to be operated more easily to save labor work, to be more robust after being locked in by having a high tensile strength and to be dismantled easily for repetitive use.

2. The concrete bolt according to claim 1, wherein helix angles formed between the high-tooth threads, low-tooth threads and the bolt body are between 15° and 25° to construct the high tensile strength.

3. The concrete bolt according to claim 1, wherein the high-tooth thread having the petal-shaped teeth is located at 0^{˜}15 or 40 mm above the bottom end of the bolt body (about 2^{˜}2.5 times of the diameter), thereby increasing the sharpness of the bolt upon being locked into the concrete.

4. The concrete bolt according to claim 1, wherein inclination angles at an upper and lower rim of the low-tooth thread are about 50°^{˜}58° to achieve the guiding and balancing functions, allowing the bolt to keep vertical during operation.
